(19) United States
(12) Patent Application Publication
(10) Pub. No.: US 2007/0198277 A1
(43) Pub. Date: Aug. 23, 2007

(54) SINGLE IDENTIFIER TRANSFORMATION SYSTEM AND METHOD

(75) Inventors: Adam L.K. Philipp, Mercer Island, WA (US); Omar F. Khandaker, Las Vegas, NV (US); Daniel J. Neistadt, Las Vegas, NV (US)

Correspondence Address: AXIOS LAW GROUP, 1725 WESTLAKE AVENUE NORTH, SUITE 150, SEATTLE, WA, 98109, US

(73) Assignee: WOW! TECHNOLOGIES, INC., Las Vegas, NV (US)

(21) Appl. No.: 11/307,346

(22) Filed: Feb. 1, 2006

(51) Int. Cl. G06Q 10/00; G06Q 30/00

(52) U.S. Cl. 705/1

(57) ABSTRACT

A single identifier system and method are provided herein.

### FIELD

The present invention generally relates to identifier cards and, more particularly, to a single identifier system and method.

### BACKGROUND

Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

Debit cards and gift cards are also well known in the art. Such cards are typically linked to a user's bank account or are purchased from a vendor and come in fixed value increments, for example, $10, $20 and $50. A $10 card provides the customer with $10 of purchasing power utilizing an existing debit card system. In the operation of prior art systems, cards are batch activated by the card provider in a limited number of predetermined values. A customer purchases one of these pre-activated cards by paying a fee. The cards typically include a predetermined identification code.

Such systems have proved commercially successful and desirable for a number of reasons. Gift cards allow customers to present recipients of gifts with a convenient and easy to use payment mechanism. However, once the card has been used by the recipient, its usefulness is exhausted, and it is generally thrown away.

Additionally, many merchants have little or no incentive to sell cards, and neither do other parties in the supply chain system. Current debit card and gift card technologies do not allow for distributing fees associated with these cards to a wide audience to create incentives to distribute the cards.

Furthermore, many consumers accumulate wallet cards for a variety of purposes, some of which they would prefer not to have to carry, such a various supermarket, frequent flyer, member and other cards.

Some card providers have tried to limit the number of separate cards to consumer carriers by providing multiple membership/account numbers on a single card. However, such systems generally are limited to two member and/or account numbers (e.g. credit card number and frequent flyer number; credit cards and store membership numbers or the like).

### BRIEF DESCRIPTION OF THE DRAWINGS

FIG. 1 is a pictorial diagram of a number of interconnected devices that provide a connected point-of-sale device with identifier processing.

FIG. 2 is a block diagram of a cash register that provides an exemplary operating environment for one embodiment.

FIG. 3 is an exemplary diagram of an identifier reader device that provides an exemplary operating environment for one embodiment.

FIG. 4 is a block diagram of an identifier intercept device that provides an exemplary operating environment for one embodiment.

FIGS. 5a-b are exemplary diagrams of a single identifier card in accordance with various embodiments.

FIG. 6 is a diagram illustrating the actions taken by devices in a single identifier system for processing an intercepted identifier in accordance with one embodiment.

FIG. 7 is a diagram illustrating alternate actions taken by devices in a single identifier system for processing transformed identifier in accordance with one embodiment.

FIG. 8 is a flow diagram illustrating an identifier intercept routine in accordance with one embodiment.

FIG. 9 is a flow diagram illustrating an identifier transformation subroutine in accordance with one embodiment.

FIG. 10 is a flow diagram illustrating an account access routine in accordance with one embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. Those of ordinary skill in the art will appreciate that other embodiments, including additional devices, or combinations of illustrated devices, may be added to, or combined, without limiting the scope to the embodiments disclosed herein.

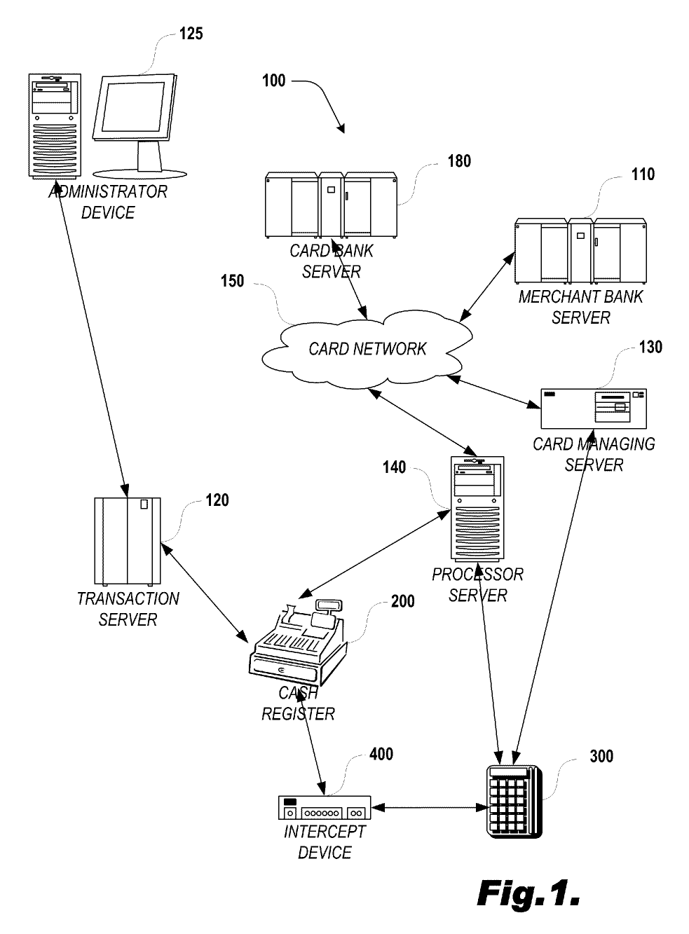

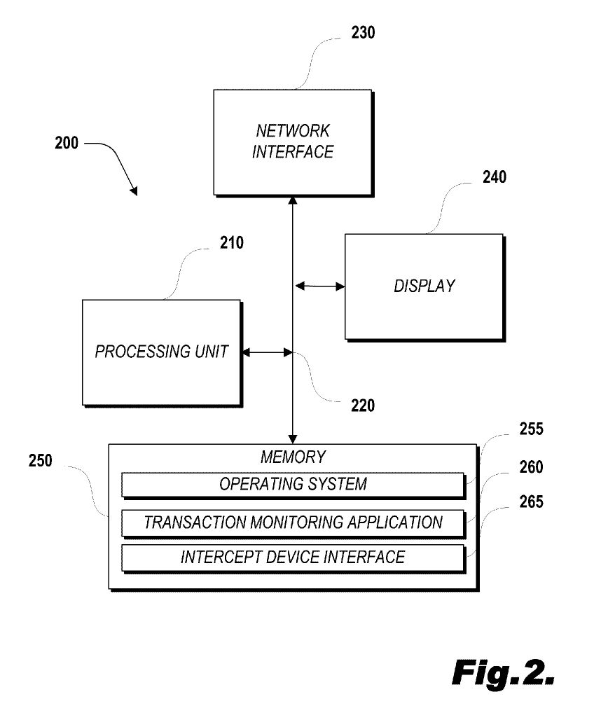

FIG. 1 illustrates an exemplary single identifier system 100 having a number of devices used in exemplary embodiments. FIG. 1 illustrates a identifier reader 300 connected to a card-managing server 130, a processor server 140 and an intercept device, illustrated in FIG. 2 and described below. Also included are a cash register, illustrated in FIG. 2 and described below, a transaction server 120, a card network 150 (such as a network provided by any of the well known debit/credit card transaction network providers, e.g., Star, Cirrus, Visa, MasterCard, American Express, Diners Club, etc.) and an administrator device 125. Also in communication with the card network 150 is a card bank server 180 and a merchant bank server 110.

In alternate embodiments, there may be a plurality bank servers, or even that the role of the card bank server 180 may be performed by another device such as merchant bank server 110. In further embodiments, still additional devices (not shown) may be utilized in the single identifier system 100. Likewise, in some embodiments, other devices (both shown and not shown) may be combined. For example, the intercept device 400 and cash register 200 may be in the same device. Alternately, the transaction server 120 or identifier reader device 300 may have intercept device functionality.

FIG. 2 illustrates several of the key components of the cash register 200. In some embodiments, the cash register 200 may include many more components than those shown in FIG. 2. However, it is not necessary that all of these generally conventional components be shown in order to disclose an illustrative embodiment. As shown in FIG. 2, the cash register 200 includes a network interface 230 for connecting to other devices in the single identifier system 100. In various embodiments, the network interface 230 includes the necessary circuitry for such a connection and is constructed for use with the appropriate protocol.

The cash register 200 also includes a processing unit 210, a memory 250 and may include a display 240, all interconnected along with the network interface 230 via a bus 220. The memory 250 generally comprises a random access memory (“RAM”), a read only memory (“ROM”), and a permanent mass storage device, such as a disk drive. The memory 250 stores the program code necessary for a transaction monitoring application 260, in addition to an intercept device interface 265. In addition, the memory 250 also stores an operating system 255. It will be appreciated that these software components may be loaded from a computer readable medium into memory 250 of the cash register 200 using a drive mechanism (not shown) associated with a computer readable medium, such as a floppy disc, tape, DVD/CD-ROM drive or via the network interface 230.

Although an exemplary cash register 200 has been described that generally conforms to conventional general purpose computing devices, those of ordinary skill in the art will appreciate that a cash register 200 may be any of a great number of devices capable of communicating with the device within the single identifier system 100.

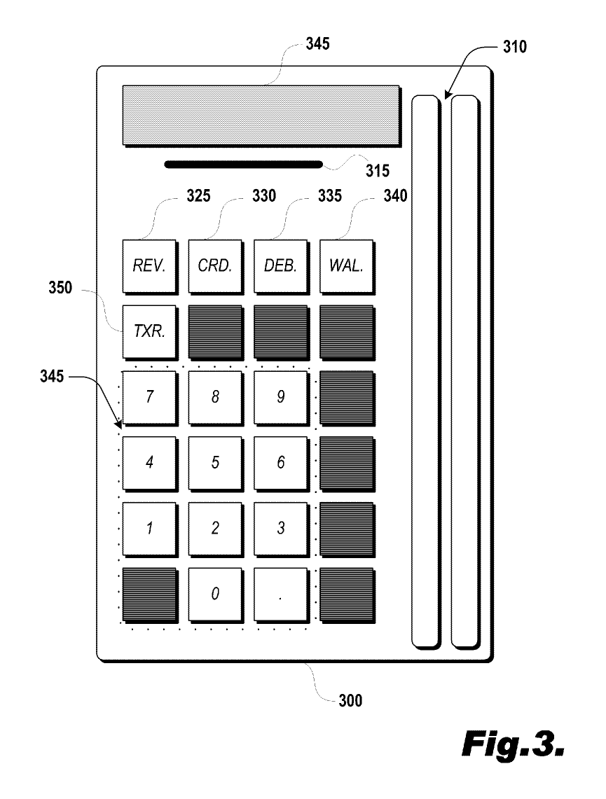

FIG. 3 depicts an exemplary identifier reader device 300 for use in various embodiments. The identifier reader device 300 may include a card swipe 310, card slot 315, credit button 330, debit button 335, wallet button 340, transfer button 350, transaction reversal button 325, display 345 and numeric entry buttons 355. Although an exemplary identifier reader device 300 has been described and shown in FIG. 3, those of ordinary skill in the art will appreciate that identifier reader devices may take many forms and may include many additional components other than those shown in FIG. 3. For example, the identifier reader device 300 may include a connection to a printer (not shown) for printing information at the identifier reader device 300. In alternate embodiments, the identifier reader 300 may be a biometric reader (e.g., fingerprint, handprint, iris and/or facial recognition device), automated teller machine, point-of-sale device, personal computer, gaming machine or the like.

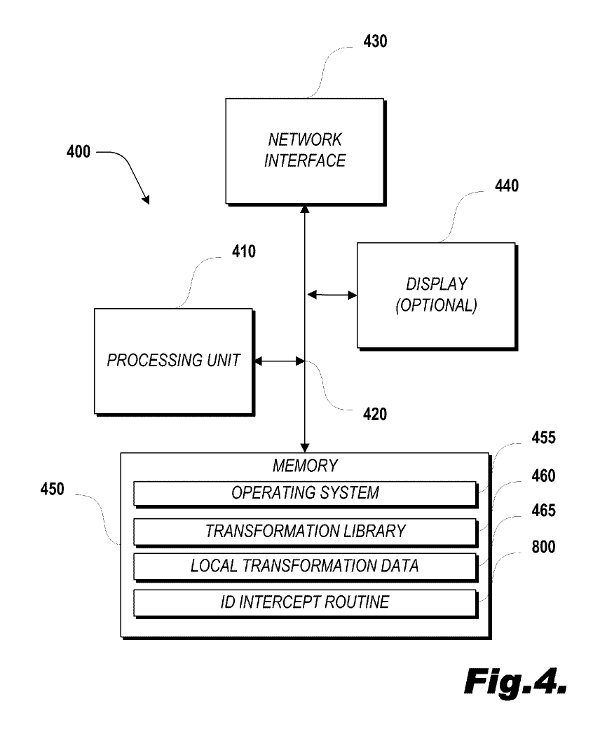

FIG. 4 illustrates several of the key components of the intercept device 400. In some embodiments, the intercept device 400 may include many more components than those shown in FIG. 4. However, it is not necessary that all of these generally conventional components be shown in order to disclose an illustrative embodiment. As shown in FIG. 4, the intercept device 400 includes a network interface 430 for connecting to devices shown in FIG. 1. Those of ordinary skill in the art will appreciate that the network interface 430 includes the necessary circuitry for such a connection and may be constructed for use with the appropriate protocol.

The intercept device 400 also includes a processing unit 410, a memory 450 and may include an optional display 440, all interconnected along with the network interface 430 via a bus 420. The memory 450 generally comprises RAM, ROM and a permanent mass storage device, such as a disk drive. The memory 450 stores the program code necessary for a identifier intercept routine 800, transformation library 460 (e.g., instructions for one or more transformation of identifiers) and local transformation data 465 (e.g., local/merchant identifiers, transformation seeds and/or “salts”). In addition, the memory 450 also stores an operating system 455. It various embodiments these software components may be loaded from a computer readable medium into memory 450 of the intercept device 400 using a drive mechanism (not shown) associated with a computer readable medium, such as a floppy disc, tape, DVD/CD-ROM drive or via the network interface 430.

Although an exemplary intercept device 400 has been described that generally conforms to conventional general purpose computing devices, those of ordinary skill in the art will appreciate that a intercept device 400 may be any of a great number of devices capable of communicating with devices in the single identifier system 100.

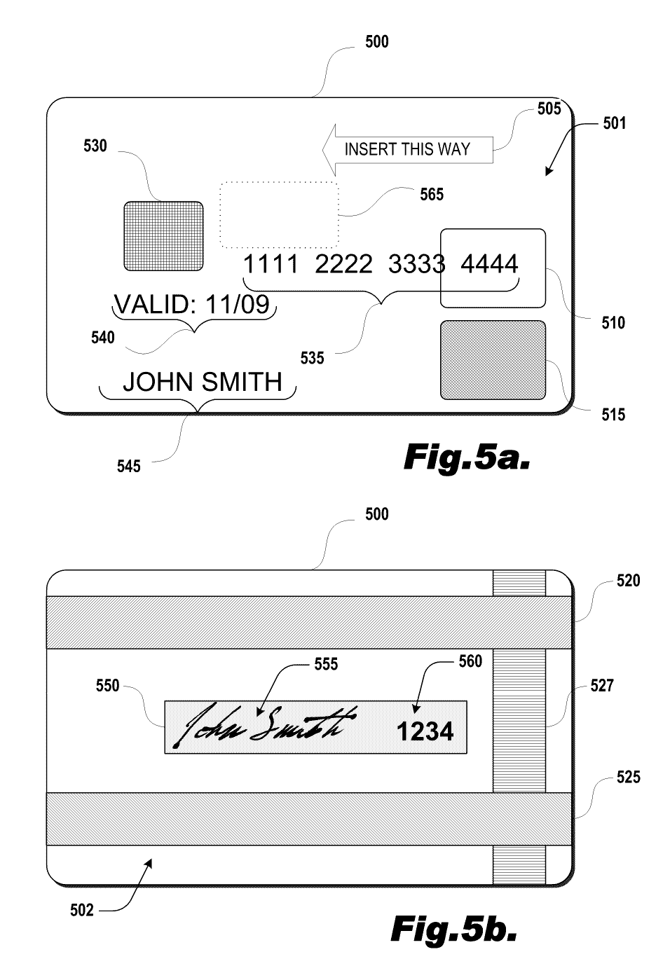

FIGS. 5a-b illustrate an exemplary single identifier card 500 suitable for use in various embodiments. FIG. 5a illustrates an exemplary front face 501 of the single identifier card 500. FIG. 5b illustrates and exemplary back face 502 of the integrate card 500. The single identifier card 500 may include one or more magnetic strips 520, 525, 527, a smart card chip interface 530, embossed account numbers 535 and/or fraud prevention components 510 (e.g., decals, photographs, holograms, etc.) as well as a card type logo 515. Likewise, in some embodiments, the single identifier card 500 may contain a card user's name 545 and an expiration date 540. In some embodiments, the single identifier card 500 may include any of the magnetic strips 520, 525, 527, smart card chip interface 530, radio frequency identification (“RFID”) circuitry 565 and embossed numbers/identifier 535 to be effective as a payment card. It will further be appreciated that additional ways of storing information or providing information on the card may also be used. In one exemplary embodiment, a security code 560 may be printed or embossed on the single identifier card 500 as well. Additionally, in some embodiments, the single identifier card 500 may have a signature block 550 having a user's signature 555.

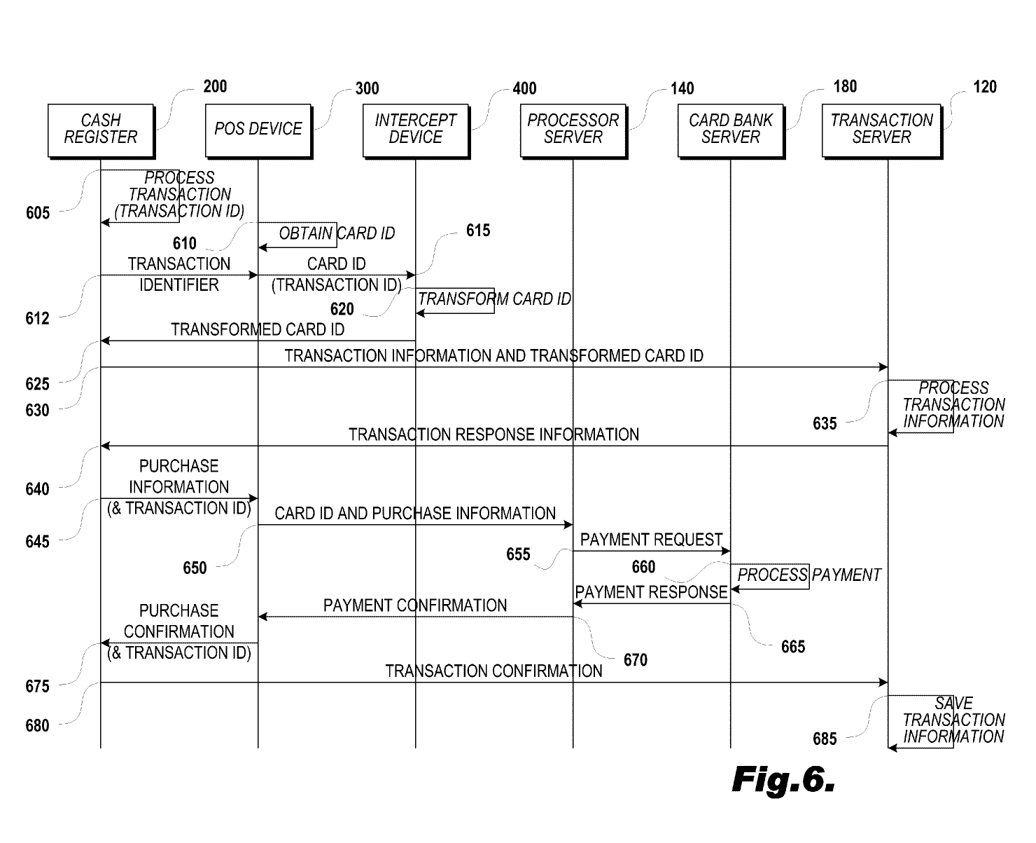

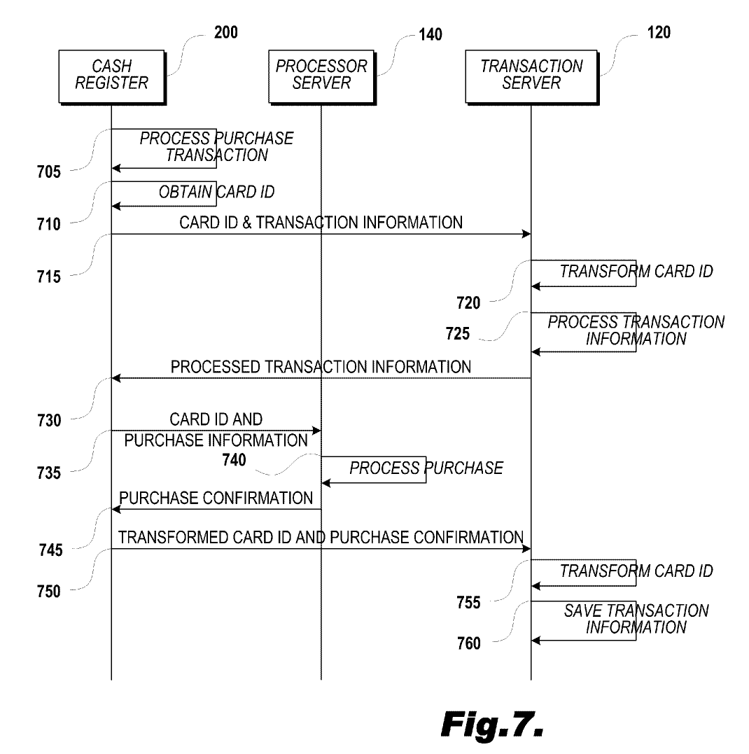

FIGS. 6-7 illustrate exemplary steps to process transactions in the single identifier system 100. Some transactions in the single identifier system 100 may be more networked than others. Accordingly, in some embodiments, the number of devices used to process a transaction is kept to minimum.

FIG. 6, for example, illustrates an exemplary “intercept” transaction where a part of the transaction originating at a cash register 200 or POS device 300 is intercepted by an intercept device 400. In the exemplary transaction illustrated in FIG. 6, the transaction involves a cash register 200, POS device 300, intercept device 400, processor server 140, card bank server 180 and a transaction server 120. The transaction begins with a cash register 200 processing 605 a transaction (e.g. a purchase transaction for goods and/or services). In some embodiments, transaction-identifying information may also be created. Likewise at a POS device 300 a card identifier is obtained 610 (in other embodiments, the identifier may be from a non-card source, such as biometric information). The transaction identifying information may be communicated 612 to the POS device 300.

Alternately, the card identifier and/or transformed card identifier may be obtained and optionally verified before any transactions and/or transaction processing takes place. Such as, but not limited to, checking a transformed card identifier to verify a membership or the like.

The POS device sends 61 5 the card identifier (and possibly transaction identifying information) to the intercept device 400 (as opposed to sending it directly to the cash register 200 as in a conventional POS transaction). The intercept device 400 transforms 620 the card identifier and transmits the transformed card identifier 625 (and possibly transaction identifying information) to the cash register 200. The cash register 200 sends 630 transaction information and transformed card identifier to the transaction server 120.

While a transaction server 120 may not be used in all embodiments, in exemplary embodiments where a merchant or merchant company maintains membership and/or consumer records, a transaction server or similar device may be employed to track transactions and/or consumer activities. Similarly, instead of, or in addition to, a transaction server 120, a membership server may be accessed using the transformed card identifier.

Continuing the transaction, the transaction server 120 processes the 635 transaction information and returns 640 transaction response information (e.g., including a modified purchase price and/or transaction identifying information) to the cash register 200. In one exemplary embodiment, the transaction server 120 may process the received transaction information to determine if discounts should be applied to currently listed prices for the goods and/or services listed in the transaction information and if so the transaction response information would reflect new pricing and/or discount information for the cash register 200.

The cash register 200 uses the transaction response information to send 645 purchase information (e.g., including a modified purchase price and/or transaction identifying information) to the POS device 300. The POS device sends 650 the card identifier (Note: not the transformed card identifier) and purchase information to a processor server 140. The processor server 140 sends a payment request 655 to a card bank server 180, which processes 660 the payment. Once the payment has been processed (e.g., possibly including transferring funds to a merchant bank server 110), the card bank server 180 returns 665 a payment response to the processor server 140.

Assuming the payment response as indicates the successful completion of the payment transaction, the processor server 140 returns 670 a payment confirmation to the POS device 300. The POS device 300 sends a purchase confirmation 675 to the cash register 200. Note, in some embodiments the purchase confirmation 675 may be routed through the intercept device 400 before being communicated to the cash register 200. Additionally, the payment confirmation may include additionally information, such as a transaction identifying information that may be used to match the purchase information 645. The cash register 200 may then send 680 the transaction confirmation to the transaction server 120. The transaction server 120 may then save 685 transaction information to its records, and in some embodiments may update the specific records corresponding to a consumer with the transformed card identifier.

Not all single identifier systems may operate in the same fashion. For example, FIG. 7 illustrates an alternate single identifier card transaction with communications between a cash register 200, processor server 140 and transaction server 120. The transaction illustrated in FIG. 7 may be referred to as a “remote transaction,” as the transformation of the card identifier takes place on the remote transaction server 120. In one exemplary embodiment, the communications to the transaction server 120 are secured (e.g., through a physically secure communications channel or via an encrypted communications channel) between the cash register 200 and the transaction server 120.

The transaction begins with the cash register 200 processing 705 a purchase transaction. The cash register 200 also obtains 710 a card identifier for use in the purchase transaction. Next, the cash register 200 sends 715 the card identifier and transaction information to the transaction server 120. The transaction server 120 transforms 720 the card identifier and processes 725 the transaction information. Once the transaction server 120 has transformed the card identifier and processed the transaction information, it sends 730 the processed transaction information back to the cash register 200. The cash register 200 sends 735 the card identifier and purchase information obtained from the processed transaction information to the processor server 140. The processor server 140 processes 740 the purchase, and upon a successful processing, returns 745 a purchase confirmation to the cash register 200. The cash register 200 sends 750 the card identifier and purchase confirmation to the transaction server 120, which again transforms 755 the card identifier (to regenerate a predictable account identifier) and save 760 the transaction information in the account associated with the predictable account identifier.

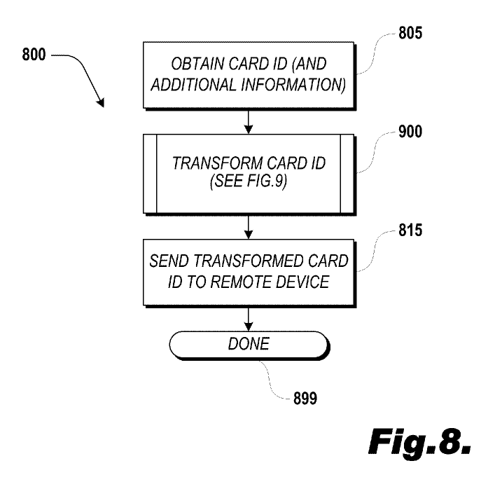

FIGS. 8-10 illustrate exemplary routines for handling single identifier transactions.

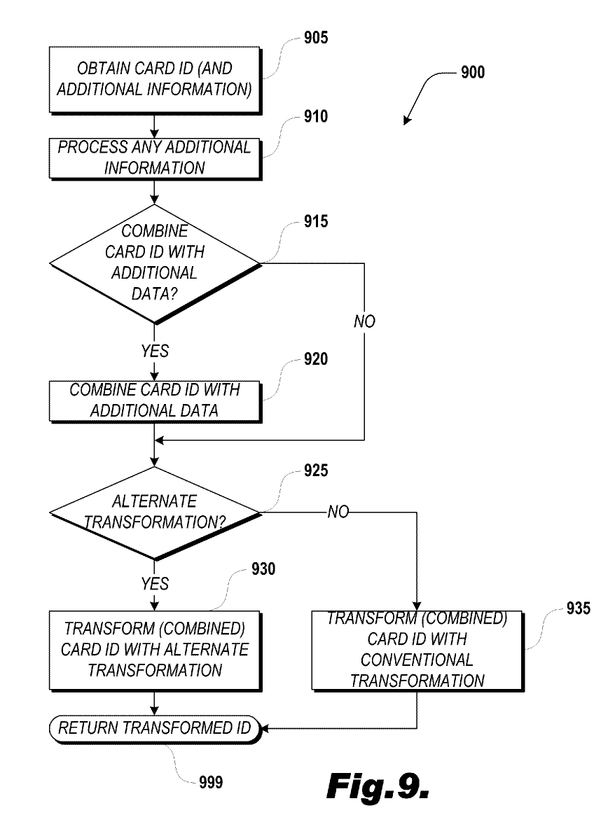

FIG. 8 illustrates an exemplary intercept routine 800. Intercept routine 800 begins at block 805, where a card identifier and possibly additional information, such as transaction information, is obtained. Next, in subroutine block 900, the card identifier is transformed. Card identifier transformation subroutine 900 is illustrated in FIG. 9 and described below. In block 815, the transformed card identifier is sent to a remote device. Intercept routine 800 ends at block 899.

Card identifier transformation subroutine 900 is illustrated in FIG. 9. Card identifier transformation subroutine 900 begins at block 905 where a card identifier and possibly additional information such as (transaction information, merchant identifying information, merchant company identifying information, teller information, location information, type of identifier information and the like) is obtained. In block 910, the additional information (if any) is processed to obtain information to be used in transforming the card identifier. In one exemplary embodiment, a card obtained from a merchant location have its card identifier incorporated along with the merchant company's identifier to form a compound identifier, however in other embodiments no additional information is combined with the card identifier. Accordingly, in decision block 915 a determination was made whether to combine the card identifier with any additional data. If no additional data is to be combined with the card identifier, processing proceeds to decision block 925. If however the card identifier is to be combined with additional data, the additional data is combined with the card identifier in block 920. In decision block 925, a determination is made whether the combined or uncombined card identifier should undergo a conventional or alternate transformation.

In some embodiments, a merchant and/or merchant company or other entity may have a particular form of card identifier transformation they use to generate a transformed identifier. This may be in lieu of or in combination with combining additional information with the card identifier. For example, a merchant company may combine card identifiers with a code from each merchant location; however, the merchant company may then provide a separate alternate transformation for its combined identifier.

Exemplary transformation used in various embodiments may include, but are not limited to encryption, cryptographic hashing, concatenation, encoding, underscore and the like. In many embodiments, it may be desirable for the transformation to be “trapdoor” transformation, such that given a non-transformed card identifier; it is difficult, if not impossible to generate the original card identifier from the transformed identifier. Strong encryption techniques and cryptographic hashing techniques are known to have these properties as well as simpler techniques such as only taking the last half of the symbols in an identifier or only taking a portion of the symbols in an identifier.

In some embodiments, the desirable characteristics of the identifier (and optional additional information) transformation may simply be that the transformation is possible to generate a likely unique identifier in a predictable manner. Such embodiments may not place a high value on the security of the transformed identifier. For example, a supermarket discount identifier may have little or no intrinsic value if replicated by someone other than a consumer or the supermarket. However, an exclusive club's membership identifier may have a high intrinsic value. The club may place a high premium in providing benefits only to its members. Accordingly, for transformed identifiers having a high intrinsic value, it may be desirable to use a secure transformation to create the transformed identifier in a secure fashion. For example the transformation may use an alternate transformation such as transforming the identifier using a public key or conventional encryption (e.g., DES, triple DES, AES, RSA, Blowfish, Two Fish, Diffie-Hellman, or the like) using a key known only to the club. Ultimately the club might combine the identifier with secret additional data that is securely transformed (e.g., with a cryptographic hash, message digest or the like) to create a predictable and hard to discover transformed identifier.

If, in decision block 925, it is determined that an alternate transformation should be used, in block 930 the (combined) card identifier is transformed using an alternate transformation, processing proceeds to block 999 where subroutine 900 returns to its calling routine. If however in decision block 925 it was determined that an alternate transformation should not be used, processing proceeds to block 935 where a conventional or default transformation takes place for the (combined) card identifier and processing proceeds to return block 999 where the transformed identifier is returned to the calling routine.

While a myriad of transformations may be employed to transform an identifier. In exemplary embodiments, it is desirable to use “one-way” transformation formulas such that an identifier is transformed in a predictable, but irreversible manner. For example, generating a cryptographic hash of the identifier. In some embodiments, the additional information received with the identifier may alter the identifier additionally. For example, the cryptographic hash could be a hash of the single identifier combined (e.g., concatenates, XORed, encrypted with, or otherwise combined with a location/merchant identifier or other additional information). By having known additional information, it is possible to repeatedly and predictable transform the single identifier into a predictably transformed identifier.

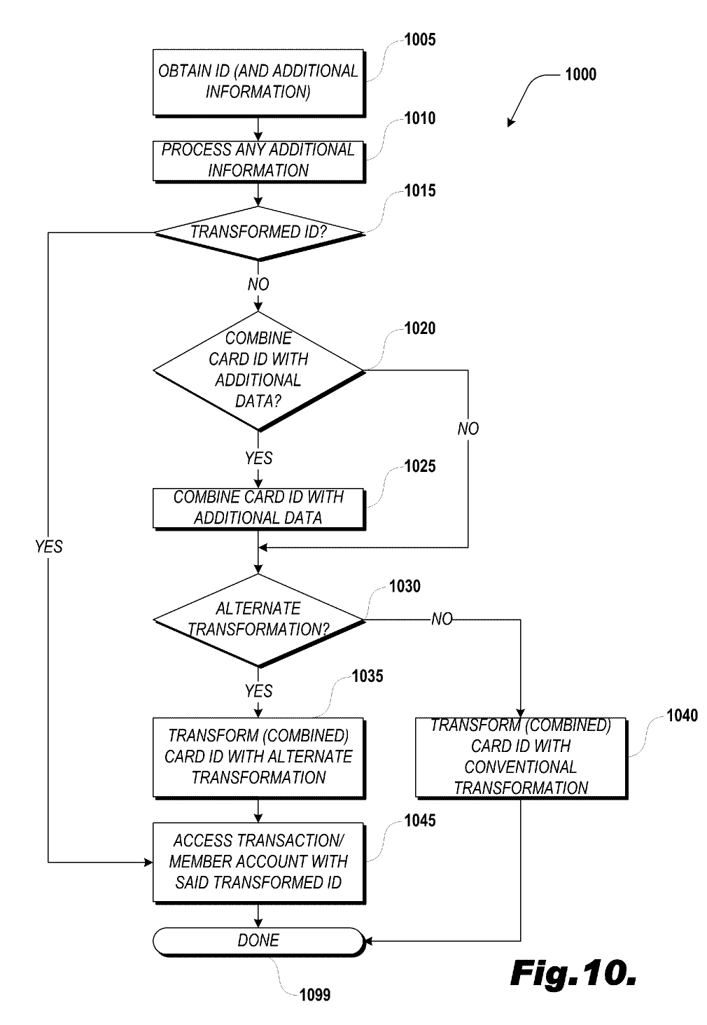

FIG. 10 illustrates a routine 1000 for accessing account information indexed by the predictably transformed identifier. Account access routine 1000 begins at block 1005 where an identifier and possibly additional information such as (transaction information, merchant identifying information, merchant company identifying information, teller information, location information, type of identifier information and the like) is obtained. In block 1010, the additional information (if any) is processed to obtain information to be used in determining how to handle the obtained identifier. Accordingly, in decision block 1015 a determination is made whether the obtained identifier is a transformed identifier. If the identifier is not a transformed identifier, processing proceeds to decision block 1020. If, however, the card identifier is a transformed identifier, processing proceed to block 1045.

In decision block 1020, a determination was made whether to combine the card identifier with any additional data. If no additional data is to be combined with the card identifier, processing proceeds to decision block 1030. If however the card identifier is to be combined with additional data, the additional data is combined with the card identifier in block 1025. In decision block 1030, a determination is made whether the combined or uncombined card identifier should undergo a conventional or alternate transformation.

If in decision block 1030 it is determined that an alternate transformation should be used, in block 1035 the (combined) card identifier is transformed using an alternate transformation, processing proceeds to block 1045. If, however, in decision block 1030 it was determined that an alternate transformation should not be used, processing proceeds to block 1040 where a conventional or default transformation takes place for the (combined) card identifier and processing proceeds to block 1045. In block 1045, the account associated with the transformed identifier is accessed. Access routine 1000 ends at block 1099.

While a number of exemplary single identifier transactions and types of identifier readers 300 have been identified, it will be apparent that in alternate embodiments other types of identifier readers 300 may process still other forms of identifier transactions, and are included within the scope. Non-card identifier tokens (e.g., dongles, chips, other identifier bearing device, and the like) as well as biometric information may be used in a variety of embodiments and with a variety of identifier readers 300.

Additionally, in various exemplary transactions, single identifiers may also be use for merchant-based credit transactions (e.g., where a merchant is acting as a credit issuer on their own behalf, such as a hotel allowing room charges or a phone company allowing telephone calls to a phone card that will later be billed for the phone services and the like).

It will be appreciated that in some embodiments, such as a conventional debit card transaction, that transaction communications may bypass the card-managing server 130 and/or transaction server 120 and communicate directly with the card bank server 180. However, in other embodiments it may be appropriate for the card-managing server 130 to maintain records of transactions and accordingly the communications may include the card-managing server 130.

In additional embodiments, the various transactions may include a mixture of transactions that allow users to shared individual, but not personally identifying information with a transaction server 120. For example, the single identifier card 500 may allow a user to transfer data (e.g., information, funds, access codes, and the like) from one type of device/account to another, but have that transaction information stored in anonymous/pseudonymous fashion.

In some embodiments, it may be beneficial to integrate a single identifier card 500 with conventional banking transactions that are performed with conventional bank accounts. Accordingly, in some embodiments, the single identifier system 100 may be implemented that allows for financial network transactions in addition to the transactions performed over a card network 150. One such alternate network is the Automated Clearinghouse (“ACH”) network (not shown).

The ACH Network is a system used by financial institutions to process millions of financial transactions each day. The system utilizes a network of ACH entities, of which many major banks are members. The transactions take place in a batch mode, by financial institutions transmitting payment instructions through the system of clearing houses. As the pace of electronic commerce quickens, and with the price advantages of ACH payments versus other payment mechanisms such as checks and wire transfers, the volume of ACH transactions will likely continue to increase.

One common form of ACH transactions for users is the ACH credit, which is the transaction type used for direct deposit of payroll. In that transaction, the employer is the Initiator of an ACH credit (the Payor) and the employee is the Receiver (the Payee) of that ACH credit. ACH debits are becoming more prevalent for users, with some adopters being health clubs who debit their members' bank accounts for club dues. In that transaction, the health club is the Initiator (the Payee) of the ACH debit, and the member being debited is the Receiver (the Payor).

The ACH System is governed by rules, policies and procedures written by The National Automated Clearing House Association (“NACHA”). Under current NACHA Rules, the Originator of an ACH debit (the payee) must have proper authorization from the Receiver of the ACH debit (the payor) before such a transaction can be initiated.

“Unauthorized” debits can be returned; however, the timeframe in which this must be done is varies. Users, on the other hand, have the protection of Regulation “E” and specific NACHA Rules relating to User accounts, which allow users to return ACH debit entries (that they document as “not authorized”) for an extended period after the original transaction date. There is also a service that allows review of ACH debits before they are posted, with the customer making the decision to accept or return the debit individually.

One specific type of ACH transaction of interest is a WEB ACH transaction. The WEB ACH transaction is a debit entry to a user bank account, for which the authorization was obtained from the Receiver (the user who owns the bank account) over the Internet. The specific designation for these types of transactions was created in order to address unique risks inherent to Internet payments.

Further details on the ACH system may be found in the 2005 ACH Operating Rules and Guidelines available from NACHA (National Automated Clearing House Association of Herndon, Va.), the entirety of which is hereby incorporated by reference. More specifically, multiple forms of ACH transactions are described therein that are suitable for use with various embodiments. An exemplary listing of transaction types (and ACH transaction codes) includes, but is not limited to:
Accounts Receivable Entry
Consumer Cross-Border Payment
Identifier reader Entry (identifier reader)
Prearranged Payment and Deposit Entry
Point-of-Purchase Entry
Shared Network Entry
Telephone-initiated Entry
Internet-initiated Entry (WEB)
ACH Payment Acknowledgment
Financial EDI Acknowledgment
Corporate Cross-Border Payment
Cash Disbursement
Cash Concentration
Corporate Trade Exchange
Customer-Initiated Entry
Automated Accounting Advice
Automated Notification of Change
Automated Return Entry
Death Notification Entry
Automated Enrollment Entry

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

What is claimed is:

1. A computer-implemented method of generating a predictable account identifier, the method comprising:
obtaining a single identifier corresponding to a payment instrument;
generating a predictable account identifier by transforming said single identifier with an irreversible function; and
associating said predictable account identifier with an account.

2. The method of claim 1 wherein obtaining said single identifier comprises receiving a manually entered identifier.

3. The method of claim 1 wherein obtaining said single identifier comprises obtaining an electronic communication comprising a representation of said single identifier.

4. The method of claim 1 wherein said single identifier is obtained from an identifier-bearing card.

5. The method of claim 4 wherein said card is selected from at least one of a magnetic stripe card, an RFID card, a chip card, a raised impression card, a printed card, and an optically coded card.

6. The method of claim 1 wherein obtaining a single identifier comprises processing biometric information.

7. The method of claim 6 wherein said biometric information is selected from at least one of fingerprint information, iris information, retinal information, handprint information, and facial recognition information.

8. The method of claim 1 wherein said single identifier is obtained from at least one of a dongle, embedded circuit, computing device, mobile electronic device and a telephone.

9. The method of claim 1 wherein generating said predictable account identifier comprises at least one of creating a cryptographic hash, creating an electronic digest, creating a hash, truncating, XORing and encrypting a representation of said single identifier.

10. The method of claim 1 wherein said generating said predictable account identifier further comprises obtaining additional information.

11. The method of claim 10 wherein said additional information comprises at least one of a merchant identifier, a company identifier, a location identifier, a date, a time, an identifier type, a seed, a salt, a PIN, and a merchant PIN.

12. A computer readable medium containing computer readable instructions for performing the method of claim 1.

13. A computing apparatus comprising a processor and a memory coupled to said processor, and containing computer readable instructions for performing the method of claim 1.

14. A computer-implemented method of processing a single identifier transaction, the method comprising:
obtaining transaction information;
obtaining a single identifier;
irreversibly transforming the single identifier into a predictable account identifier; and
communicating said predictable account number and said transaction information to a remote device.

15. The method of claim 14 wherein obtaining said single identifier comprises receiving a manually entered identifier.

16. The method of claim 14 wherein obtaining said single identifier comprises obtaining an electronic communication comprising a representation of said single identifier.

17. The method of claim 14 wherein said single identifier is obtained from an identifier-bearing card.

18. The method of claim 4 wherein said card is selected from at least one of a magnetic stripe card, an RFID card, a chip card, a raised impression card, a printed card, and an optically coded card.

19. The method of claim 14 wherein obtaining a single identifier comprises processing biometric information.

20. The method of claim 19 wherein said biometric information is selected from at least one of fingerprint information, iris information, retinal information, handprint information, and facial recognition information.

21. The method of claim 14 wherein said single identifier is obtained from at least one of a dongle, embedded circuit, computing device, mobile electronic device and a telephone.

22. The method of claim 14 wherein irreversibly transforming the single identifier into a predictable account identifier comprises at least one of creating a cryptographic hash, creating an electronic digest, creating a hash, truncating, XORing and encrypting a representation of said single identifier.

23. The method of claim 14 wherein said irreversibly transforming the single identifier into a predictable account identifier further comprises obtaining additional information.

24. The method of claim 23 wherein said additional information comprises at least one of a merchant identifier, a company identifier, a location identifier, a date, a time, an identifier type, a seed, a salt, a PIN, and a merchant PIN.

25. A computer readable medium containing computer readable instructions for performing the method of claim 14.

26. A computing apparatus comprising a processor and a memory coupled to said processor, and containing computer readable instructions for performing the method of claim 14.

27. A computer-implemented method of processing a non-payment traction with a single identifier payment instrument, the method comprising:
obtaining the single identifier of the single identifier payment instrument;
irreversibly transforming the single identifier into a predictable account identifier; and
communicating said predictable account number and said transaction information to a remote device.

28. The method of claim 27 wherein obtaining said single identifier comprises receiving a manually entered identifier.

29. The method of claim 27 wherein obtaining said single identifier comprises obtaining an electronic communication comprising a representation of said single identifier.

30. The method of claim 27 wherein said single identifier is obtained from an identifier-bearing card.

31. The method of claim 30 wherein said card is selected from at least one of a magnetic stripe card, an RFID card, a chip card, a raised impression card, a printed card, and an optically coded card.

32. The method of claim 27 wherein obtaining a single identifier comprises processing biometric information.

33. The method of claim 32 wherein said biometric information is selected from at least one of fingerprint information, iris information, retinal information, handprint information, and facial recognition information.

34. The method of claim 27 wherein said single identifier is obtained from at least one of a dongle, embedded circuit, computing device, mobile electronic device and a telephone.

35. The method of claim 27 wherein irreversibly transforming the single identifier into a predictable account identifier comprises at least one of creating a cryptographic hash, creating an electronic digest, creating a hash, truncating, XORing and encrypting a representation of said single identifier.

36. The method of claim 27 wherein said irreversibly transforming the single identifier into a predictable account identifier further comprises obtaining additional information.

37. The method of claim 36 wherein said additional information comprises at least one of a merchant identifier, a company identifier, a location identifier, a date, a time, an identifier type, a seed, a salt, a PIN, and a merchant PIN.

38. A computer readable medium containing computer readable instructions for performing the method of claim 27.

39. A computing apparatus comprising a processor and a memory coupled to said processor, and containing computer readable instructions for performing the method of claim 27.

40. A computer-implemented method of processing a first single identifier transaction for a single identifier, the method comprising:
obtaining transaction information;
obtaining a single identifier;
irreversibly transforming the single identifier into a predictable account identifier;
creating an account associated with said predictable account number; and
associating said transaction information with said predictable account number.

41. A computer readable medium containing computer readable instructions for performing the method of claim 40.

42. A computing apparatus comprising a processor and a memory coupled to said processor, and containing computer readable instructions for performing the method of claim 40.
